(19) United States
(12) Patent Application Publication
(10) Pub. No.: US 2014/0167723 A1
(43) Pub. Date: Jun. 19, 2014

(54) Switching Regulator

(71) Applicant: ANPEC ELECTRONICS CORPORATION, Hsin-Chu (TW)

(72) Inventors: Yueh-Lung Kuo, New Taipei City (TW); Chih-Yuan Chen, Hsinchu City (TW)

(73) Assignee: ANPEC ELECTRONICS CORPORATION, Hsin-Chu (TW)

(21) Appl. No.: 13/787,811

(22) Filed: Mar. 7, 2013

(30) Foreign Application Priority Data
Dec. 14, 2012 (TW) 101147545

(51) Int. Cl. G05F 1/46

(52) U.S. Cl. CPC G05F 1/46
USPC 323/283

(57) ABSTRACT

A switching regulator includes a lower gate switch and a transient help module. The lower gate switch is utilized for turning on and turning off according to a lower gate control signal. The transient help module includes a load detecting unit, for outputting a detecting signal according to a variation of a load, and a logic circuit, for generating the lower gate control signal according to the detecting signal, to turn off the lower gate switch when the load decreases.

### BACKGROUND OF THE INVENTION

1. Field of the Invention

The present invention relates to a switching regulator, and more particularly, to a switching regulator capable of turning off a lower gate switch when a load decreases and rapidly reducing inductor power by turning on a body diode of a lower gate switch, so as to effectively prevent the output voltage from overshooting.

2. Description of the Prior Art

Power supply devices play important roles in the modern information technology. Among all the power supply devices, DC-DC switching regulators have been widely used, and are mainly utilized for providing a stable DC power supply for electronic elements. Please refer to FIG. 1, which is a schematic diagram of a DC-DC switching regulator 10 with a constant on-time structure in the prior art. The DC-DC switching regulator 10 provides a stable output voltage Vout1 for a load Load1, and includes an upper gate switch 100, a lower gate switch 102, a constant time triggering circuit 104, a comparator 106, an inductor L1, a capacitor C1 and an inverter INV1. The upper gate switch 100, the lower gate switch 102, the inductor L1 and the capacitor C1 can be considered as a power stage circuit 108 to output an output voltage Vout1 to the load Load1 according to a control signal Con. The constant time triggering circuit 104 outputs the control signal Con with a constant on-time Ton for each on-time, to control on and off states of the upper gate switch 100 and the lower gate switch 102.

In short, each time when the output voltage Vout1 is less than a reference voltage Vref1, a comparison result Com outputted by the comparator 106 controls the constant time triggering circuit 104 to output the control signal Con activated with an on-time Ton. Therefore, the DC-DC switching regulator 10 turns on the upper gate switch 100 and turns off the lower gate switch 102 within the on-time Ton, such that an exterior voltage source Vin1 delivers power to the inductor L1 via the upper gate switch 100, to output a charging current IL to charge the capacitor C1. Thus the output voltage Vout1 outputted to the load Load1 increases (the voltage across the capacitor C1). When the output voltage Vout1 exceeds a reference voltage Vref1, the upper gate switch 100 is turned off and the lower gate switch 102 is turned on, such that the output voltage Vout1 starts to decrease. In other words, when the upper gate switch 100 is turned off, the output voltage Vout1 of the DC-DC switching regulator 10 starts to decrease. The upper gate switch 100 is turned on again until the output voltage Vout1 is less than the reference voltage Vref1. As a result, the DC-DC switching regulator 10 regulates the power delivered to the load Load1 by controlling on and off states of the upper gate switch 100, to maintain the stability of the output voltage Vout1.

Besides, when a value and a load current ILoad1 thereof of the load Load1 change, the frequency of the control signal Con activated with the on-time Ton changes accordingly, to maintain the stability of the output voltage Vout1. In other words, since each on-time of the control signal Con is the on-time Ton, and the off-time is variable, the frequency of the control signal Con activated with the on-time Ton varies with the value and the load current ILoad1 thereof of the output load Load1. Although the frequency of the control signal Con activated with the on-time Ton varies accordingly with the value of the load Load1, the DC-DC switching regulator 10 still can not react rapidly to maintain the stability of the output voltage.

Please refer to FIG. 2A to 2C, which are signal diagrams of the DC-DC switching regulator 10 shown in FIG. 1 when the load current ILoad1 of the load Load1 decreases. When the load value is fixed and the output voltage Vout1 is less than the reference voltage Vref1, the constant time triggering circuit 104 activates the control signal Con with the on-time Ton. As a result, the control signal Con activates with the on-time Ton by a constant frequency. The on-time Ton is related to the ratio of the output voltage Vout1 and the exterior voltage source Vin1, to stably output the output voltage Vout1.

However, as shown in FIG. 2A to 2C, the output voltage Vout1 increases due to a decrease of the value of the load Load1. The output voltage Vout1 therefore continues to be greater than the reference voltage Vref1, such that the comparison result Com stops the constant time triggering circuit 104 to activate the control signal Con with the constant on-time Ton, to reduce the output voltage Vout1 to the original stable output level. Nevertheless, under a worst condition, i.e., the control signal Con is activated with the constant on-time Ton when the load current ILoad1 of the load Load1 suddenly decreases, the output voltage Vout1 increases due to a sudden decrease of the load current ILoad1 of the load Load1, and also increases due to the activation of the on-time Ton. Hence, the output voltage Vout1 overshoots and can not be reduced rapidly to the original stable output level. Thus, there is a need for improvement of the prior art.

### SUMMARY OF THE INVENTION

It is therefore an objective of the present invention to provide a switching regulator capable of turning off a lower gate switch when a load decreases and rapidly reducing an inductor power by turning on a body diode of a lower gate switch, so as to effectively prevent the output voltage from overshooting.

The present invention discloses a switching regulator includes a lower gate switch and a transient help module. The lower gate switch is utilized for turning on and turning off according to a lower gate control signal. The transient help module includes a load detecting unit, for outputting a detecting signal according to a variation of a load, and a logic circuit, for generating the lower gate control signal according to the detecting signal, to turn off the lower gate switch when the load decreases.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a DC-DC switching regulator 10 with a constant on-time structure in the prior art.

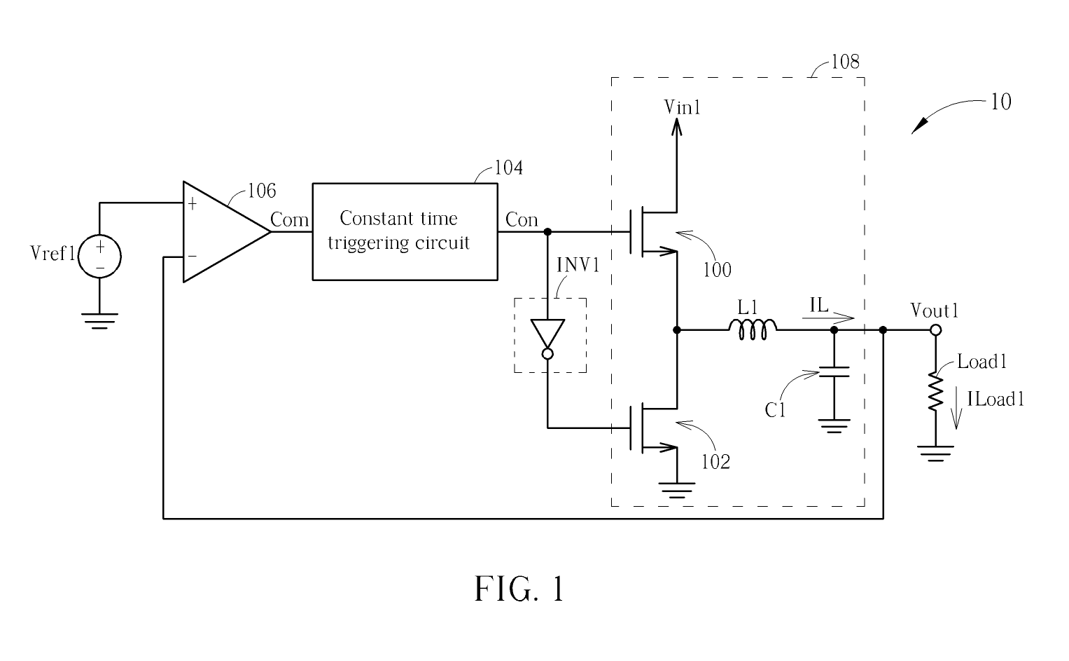

FIG. 2A to 2C are signal diagrams of the DC-DC switching regulator 10 shown in FIG. 1 when the load current ILoad1 of the load Load1 decreases.

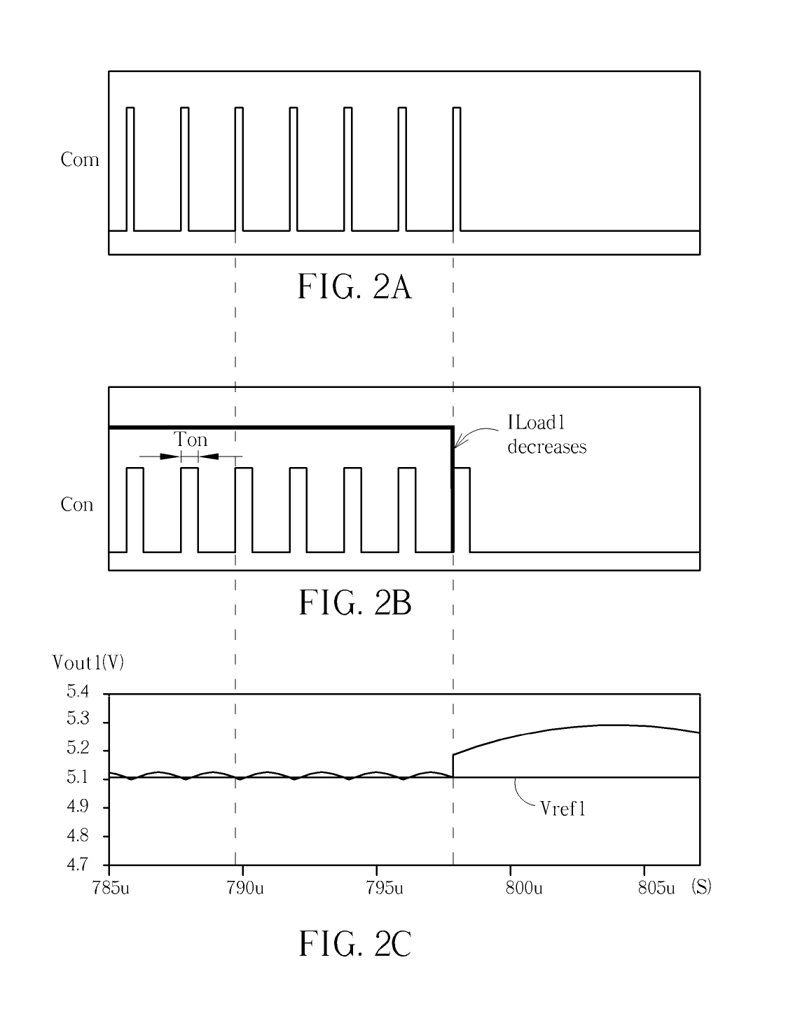

FIG. 3 is a schematic diagram of a DC-DC switching regulator 10 with a constant on-time structure.

FIG. 4 is a schematic diagram of a DC-DC switching regulator according to an embodiment of the present invention.

FIG. 5 is a schematic diagram of another DC-DC switching regulator according to an embodiment of the present invention.

FIG. 6 is a signal comparison diagram of the DC-DC switching regulator in FIG. 3 and the DC-DC switching regulators in FIG. 4 and FIG. 5.

### DETAILED DESCRIPTION

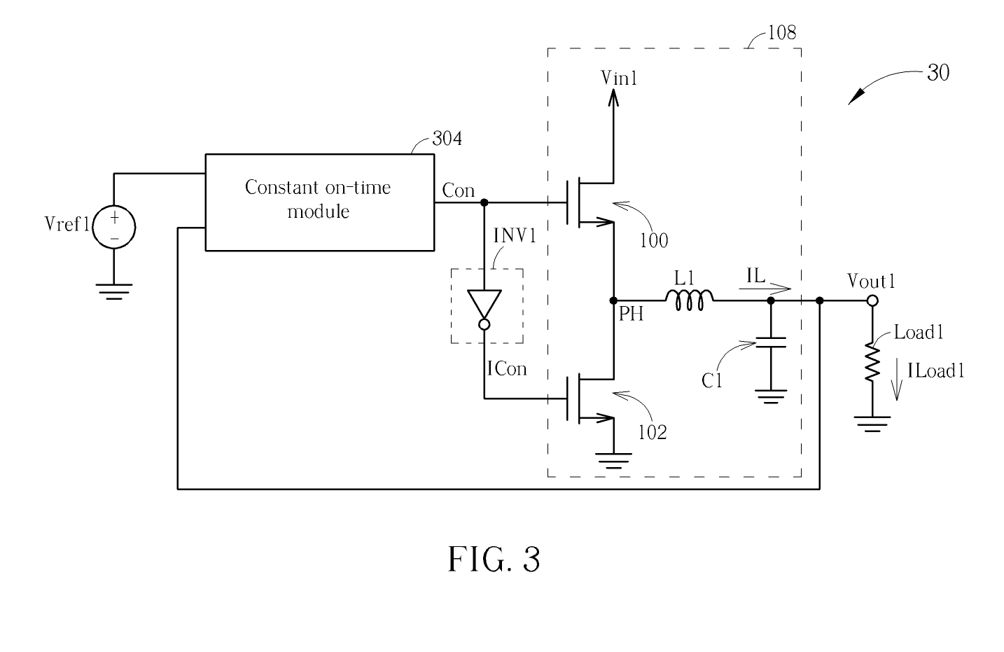

Please refer to FIG. 3, which is a schematic diagram of a DC-DC switching regulator 10 with a constant on-time structure. A structure and an operating principle of the DC-DC switching regulator 30 and those of the DC-DC switching regulator 10 are similar in parts, so elements with the same function and signals are denoted by the same symbol for simplicity. A difference between the DC-DC switching regulator 30 and the DC-DC switching regulator 10 is that the DC-DC switching regulator 30 replaces the constant time triggering circuit 104 and the comparator 106 with a constant on-time (COT) module 304. The constant on-time module 304 adjusts the off-time of the control signal Con according to the variation of the load Load1.

For this structure, a reference voltage Vref1 in the constant on-time module 304 decreases when the output voltage Vout1 increases, and increases when the output voltage Vout1 decreases. Moreover, when the reference voltage Vref1 is less than an under-clamping voltage VCL (0.9V), the constant on-time module 304 controls the control signal Con all with off-time by an off signal SD, to rapidly reduce the output voltage Vout1 to the original stable output level when the value of the load Load1 decreases. For detailed contents related to the DC-DC switching regulator 30, please refer to U.S. patent application Ser. No. 12/982,889. However, the output voltage Vout1 in the DC-DC switching regulator 30 still can not be effectively prevented from overshooting, and hence there is still a need for improvement.

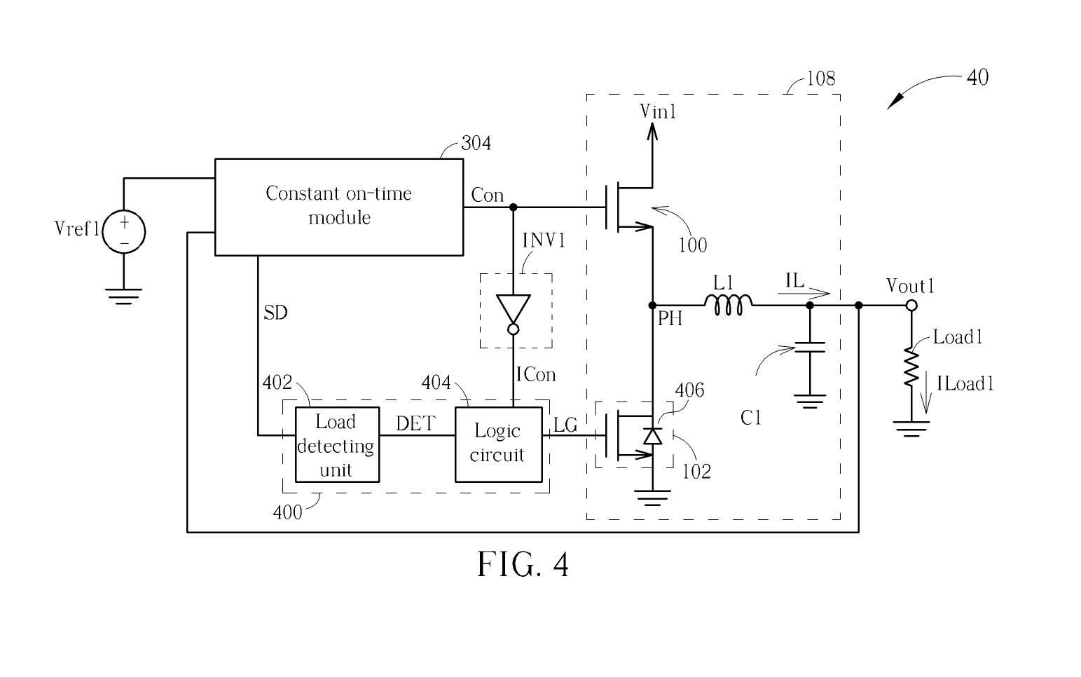

Please refer to FIG. 4, which is a schematic diagram of a DC-DC switching regulator 40 according to an embodiment of the present invention. A structure and an operating principle of the DC-DC switching regulator 40 are similar in parts to those of the DC-DC switching regulator 30, so elements with the same function and signals are denoted by the same symbol for simplicity. Differences between the DC-DC switching regulator 40 and the DC-DC switching regulator 30 are that a lower gate switch 102 in the DC-DC switching regulator 40 is turned on and off according to a lower gate control signal LG, and that the DC-DC switching regulator 40 further includes a transient help module 400 to effectively prevent the output voltage Vout1 from overshooting.

In detail, the transient help module 400 includes a load detecting unit 402 and a logic circuit 404. The load detecting unit 402 outputs a detecting signal DET according to variation of the load Load1 and the load current ILoad1 thereof. The logic circuit 404 generates the lower gate control signal LG according to the detecting signal DET, to turn off the lower gate switch 102 when the load Load1 decreases. At this moment, both the upper gate switch 100 and the lower gate switch 102 are turned off and are not synchronous in operation (The lower gate switch 102 in the DC-DC switching regulator 30 turns on and off according to an inverting signal of the control signal Con, and is synchronized in operation with the upper gate switch 100). As a result, the logic circuit 404 generates the lower gate control signal LG with logic low to turn off the lower gate switch 102 when the output voltage Vout1 starts overshooting due to decrease of the load Load1 and the load current ILoad1 thereof. Therefore, a body diode of the lower gate switch 102 turns on to rapidly reduce the power of the inductor L1, so as to effectively preventing the output voltage Vout1 from overshooting.

Specifically, the load detecting unit 402 outputs the detecting signal DET according to the off signal SD outputted by the constant on-time module 304. The logic circuit 404 selects either a lower gate off signal LGOFF with logic low or an inverting signal of the control signal Con as the lower gate control signal LG according to the detecting signal DET. Therefore, when the off signal SD indicates the load Load1 decreases, the load detecting unit 402 outputs the detecting signal DET to indicate the load Load1 and the load current ILoad1 thereof decreases, and the logic circuit 404 selects the lower gate off signal LGOFF with logic low as the lower gate control signal LG to turn off the lower gate switch 102. In such a situation, compared with the DC-DC switching regulator 30 (which continuously turns on the lower gate switch 102 when the load Load1 decreases, such that a voltage of a node PH only decreases with a charging current IL multiplies a turn-on resistance of the lower gate switch 102 from a ground terminal voltage level, and the turn-on resistance is smaller by conducting the channel of the lower gate switch 102, and thus there is a limit for reducing power of an inductor L1 and the output voltage Vout1 still overshoots), the present invention turns off the lower gate switch 102 when the load Load1 and the load current ILoad1 thereof decrease, such that the voltage of the node PH decreases with a voltage across the body diode 40 from aground terminal voltage level, and the turn-on resistance is larger by conducting the channel of the body diode 406, and thus power of the inductor L1 is reduced faster and the output voltage Vout1 is effectively prevented from overshooting.

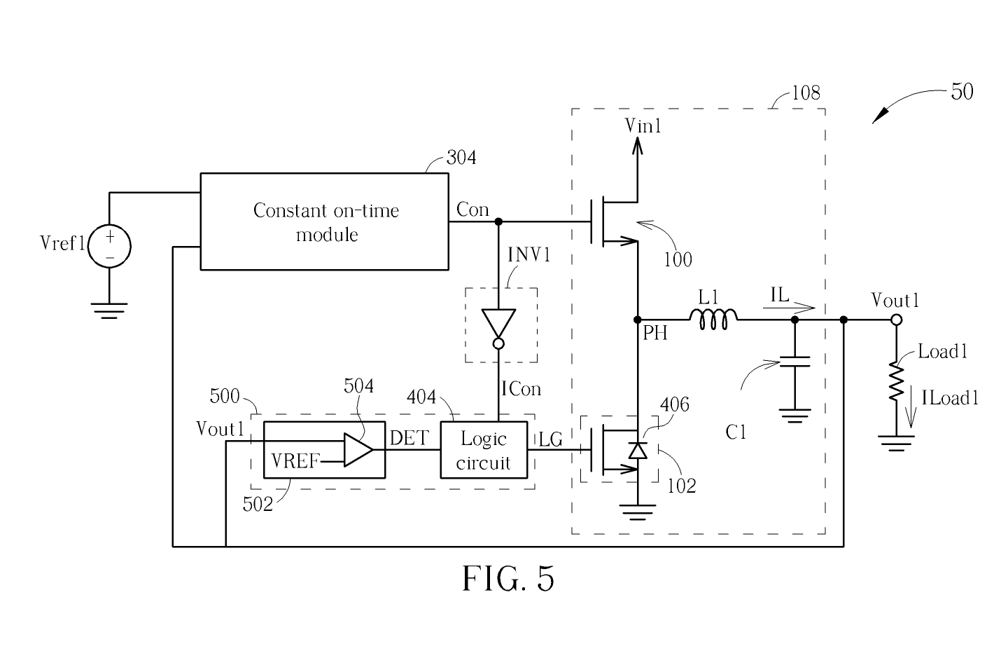

Noticeably, in the above embodiment, the load detecting unit 402 outputs the detecting signal DET to indicate the load Load1 and the load current ILoad1 thereof decreases according to the off signal SD outputted by the constant on-time module 304 (the constant on-time module 304 outputs the off signal SD according to the reference voltage Vref1 related to the output voltage Vout1), but the load detecting unit 402 can also detect variation of the load Load1 and the load current ILoad1 thereof by other manners. For example, please refer to FIG. 5, which is a schematic diagram of another DC-DC switching regulator 50 according to an embodiment of the present invention. A structure and an operating principle of the DC-DC switching regulator 50 and the DC-DC switching regulator 40 are similar in parts, so elements with the same function and signals are denoted by the same symbol for simplicity. A difference between the DC-DC switching regulator 50 and the DC-DC switching regulator 40 is that the load detecting unit 502 of a transient help module 500 of the DC-DC switching regulator 50 includes a comparator 504, which generates the detecting signal DET according to the output voltage Vout1 and a reference voltage VREF. Therefore, the comparator 504 generates the detecting signal DET to indicate the load Load1 and the load current ILoad1 thereof decreases by itself when the output voltage Vout1 is greater than the reference voltage VREF (e.g. the reference voltage VREF can be designed as 105% of the desired stable output voltage Vout1), without receiving the off signal SD outputted by the constant on-time module 304 for detection. The load detecting unit 502 only needs to add related circuit of the comparator 504.

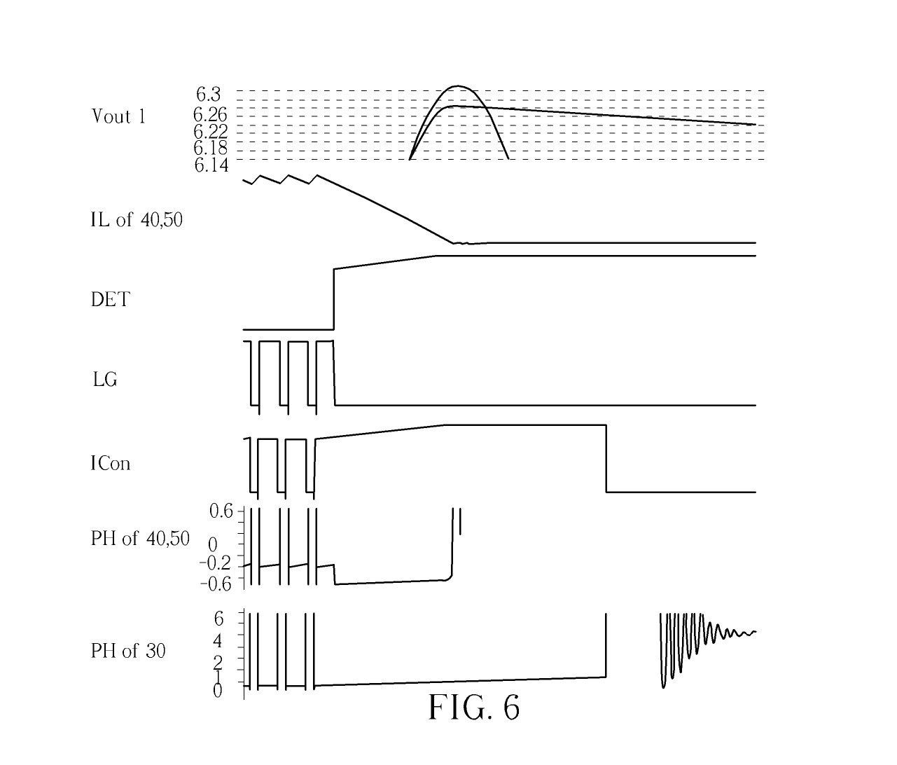

On the other hand, please refer to FIG. 6, which is a signal comparison diagram of the DC-DC switching regulator 30 in FIG. 3 and the DC-DC switching regulators 40, 50 in FIG. 4 and FIG. 5. As shown in FIG. 6, when the detecting signal DET changes a state to indicate the load Load1 decreases (according to the off signal SD or by a determination of the comparator 504), the lower gate switch 102 in the DC-DC switching regulators 40 and 50 continuously turns off according to the lower gate control signal LG, and the lower gate switch 102 in the DC-DC switching regulator 30 continuously turns on according to the inverting signal ICon of the control signal Con. Therefore, the voltage of the node PH in the DC-DC switching regulator 40 and 50 decreases a voltage across the body diode 40 from a ground terminal voltage level (to about −0.7 V), and the voltage of the node PH in the DC-DC switching regulator 30 only decreases with a charging current IL multiplies a turn-on resistance of the lower gate switch 102 from a ground terminal voltage level (to about −0.1 V). Thus the output voltage Vout1 in the DC-DC switching regulator 30 overshoots with higher degree when the load Load1 decreases (such as above about 6.3 V as indicated by a solid line), and the output voltage Vout1 in the DC-DC switching regulator 40 and 50 overshoots with lower degree (such as to about 6.26 V as indicated by a solid line). FIG. 6 only illustrates a waveform near the highest point of the output voltage Vout1. In practice, the output voltage Vout1 increases from 5 V when the detecting signal DET changes a state.

Noticeably, the spirit of the present invention is to rapidly turn off the upper gate switch 100 and turn off the lower gate switch 102 when the output voltage Vout1 starts overshooting due to decreases of the load Load1 and the load current ILoad1 thereof, such that the body diode 406 of the lower gate switch 102 is turned on to rapidly reduce power of the inductor L1 so as to effectively prevent the output voltage Vout1 from overshooting. Those skilled in the art can make modifications or alterations accordingly. For example, the method of generating the detecting signal DET is not limited to the above embodiments, such as by the off signal SD outputted from the constant on-time module 304 or by the comparator 504 directly detecting the output voltage Vout1, as long as that decreases of the load Load1 and the load current ILoad1 thereof and thus transient variation of the output voltage Vout1 can be determined. Besides, the logic circuit 404 can be implemented by a multiplier, which outputs the lower gate off signal LGOFF in logic low (i.e. a low voltage level signal) as the lower gate control signal LG when the detecting signal DET is with logic high, and outputs the inverting signal ICon of the control signal Con as the lower gate control signal LG when the detecting signal DET is with logic low. However, in other embodiments, the logic circuit 304 can be implemented by other methods, as long as the function is achieved. Moreover, the transient help module of the present invention is implemented together with the constant on-time module 304 in the above embodiment. However, the transient help module of the present invention can be implemented separately from the constant on-time module 304 (i.e. applying the transient help module 50 in the DC-DC switching regulator 10) to effectively preventing the output voltage Vout1 from overshooting.

In the prior art, when the values of load Load1 and the load current ILoad1 thereof decrease, the activated on-time in the control signal Con is still with the constant on-time Ton, such that the output voltage Vout1 overshoots and can not rapidly be reduced to the original stable output voltage level. In comparison, the present invention can turn off the lower gate switch 102 when the load Load1 and the load current ILoad1 thereof decrease and the output voltage Vout1 starts overshooting, such that the body diode of the lower gate switch 102 is turned on to rapidly reduce power of the inductor L1, so as to effectively prevent the output voltage Vout1 from overshooting.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A switching regulator, comprising:
a lower gate switch, for turning on and turning off according to a lower gate control signal; and
a transient help module, comprising:
a load detecting unit, for outputting a detecting signal according to a variation of a load; and
a logic circuit, for generating the lower gate control signal according to the detecting signal, to turn off the lower gate switch when the load decreases.

2. The switching regulator of claim 1, wherein when the load decreases and the lower gate switch is turned off by the lower gate control signal, a body diode of the lower gate switch is turned on to reduce a power on an inductor of the switching regulator.

3. The switching regulator of claim 1 further comprising a constant on-time (COT) module, for adjusting an off time of a control signal according to the variation of the load.

4. The switching regulator of claim 3, wherein the logic circuit selects one of a lower gate off signal and an inverting signal of the control signal as the lower gate control signal according to the detecting signal.

5. The switching regulator of claim 4, wherein the logic circuit selects the lower gate off signal as the lower gate control signal to turn off the lower gate switch when the detecting signal indicates the load decreases.

6. The switching regulator of claim 3, wherein the load detecting unit outputs the detecting signal according to an off signal outputted by the constant on-time module.

7. The switching regulator of claim 1, wherein the load detecting unit comprises a comparator, for generating the detecting signal according to an output voltage of the switching regulator and a reference voltage.

8. The switching regulator of claim 7, wherein the comparator generates the detecting signal to indicate the load decreases when the output voltage is greater than the reference voltage.

9. The switching regulator of claim 1, wherein when the load decreases and the logic circuit generates the lower gate control signal to turn off the lower gate switch, the lower gate switch and an upper gate switch of the switching regulator are not synchronous in operation.
